(19) United States
(12) Patent Application Publication
(10) Pub. No.: US 2007/0291284 A1
(43) Pub. Date: Dec. 20, 2007

(54) Image Forming Apparatus and Thumbnail Image Generating Method

(75) Inventors: Fumiyoshi KITTAKA, Kanagawa-ken (JP); Yasukazu Kobayashi, Shizuoka-ken (JP); Yuya Oka, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/425,310

(22) Filed: Jun. 20, 2006

(51) Int. Cl. G06F 3/12

(52) U.S. Cl. 358/1.1; 358/1.15

(57) ABSTRACT

The invention relates to an image forming apparatus capable of executing plural jobs and capable of generating a thumbnail image representing a history of execution of the jobs. The image forming apparatus includes a condition setting unit that sets a condition for generating the thumbnail image and a log generating unit. The log generating unit generates a thumbnail log of the job executed on the basis of the condition set by the condition setting unit, when any one of the jobs is executed in the image forming apparatus, and generates a thumbnail image using this thumbnail log.

### BACKGROUND OF THE INVENTION

1. Field of the Invention

The present invention relates to image forming apparatuses such as an MFP (Multi-Function Peripherals), which is digital complex machine, a copying machine, and a printer and a thumbnail image generating method and makes it possible to convert information on jobs used into thumbnails and display the thumbnails.

2. Description of the Related Art

In general, image forming apparatuses such as an MFP, a copying machine, and a printer have plural job functions such as a copy function and a scan function. It is also possible to connect an MFP and a PC (personal computer) via a network to print image data generated by the PC using the MFP or transmit image data scanned and read by the MFP to the PC.

In such image forming apparatuses of a compound type, in order to grasp histories of use of the apparatuses, information on jobs used are reduced and displayed and is displayed as a so-called thumbnail image. For example, there is a function for converting scanned images, copied images, and the like into thumbnails and storing the thumbnails. This makes it possible to display the images as thumbnails using PCs and the like connected via a network.

JP-A-2001-337994 describes a thumbnail display system that generates a thumbnail image using a computer and displays the thumbnail image with additional information for identification superimposed thereon. In this example, the additional information is used as a retrieval key to make it possible to retrieve the thumbnail image.

JP-A-2001-160882 describes a copy control apparatus that has a scanner and a printer and is connected to a network and used. In this example, thumbnail image data indicating a progress state of copying is transmitted from the copy control apparatus to a computer on the network to make it possible to grasp the progress state of copying with the computer on a real time basis.

However, in the conventional image forming apparatuses, since thumbnail logs are stored for all jobs used, there is a disadvantage that data of logs excessively increases in size. Since data of thumbnails is image data, when a data amount increases, it becomes difficult to retrieve necessary information out of enormous data, causing deterioration in efficiency. In particular, in an MFP, since there are many kinds of jobs such as scan, copying, fax transmission and reception, e-mail transmission and reception, and network printing, the excessive increase in size of data of thumbnail logs is inevitable.

The present invention provides an image forming apparatus that makes it possible to efficiently display information on jobs used in a form of thumbnails and a thumbnail image generating method.

### DESCRIPTION OF THE DRAWINGS

FIG. 1 is a diagram of a network that uses an image forming apparatus of the invention;

FIG. 2 is a block diagram for explaining a structure of the image forming apparatus of the invention;

FIGS. 3A to 3F are diagrams for explaining operations in setting conditions for storing a thumbnail log in the image forming apparatus of the invention;

FIG. 4 is a diagram for explaining an example of conditions for storing a thumbnail log stored in a nonvolatile memory in the image forming apparatus of the invention;

FIG. 5A is a diagram for explaining an example of a job log stored in a log storing unit in the image forming apparatus of the invention;

FIG. 5B is a diagram for explaining an example of job images stored in an image storing unit in the image forming apparatus of the invention;

FIG. 6 is a diagram for explaining an example of display of thumbnail images in the image forming apparatus of the invention; and

FIG. 7 is a flowchart for explaining operations of generation and storage of a thumbnail log in the image forming apparatus of the invention.

### DETAILED DESCRIPTION OF THE INVENTION

Throughout this description, the embodiment and example shown should be considered exemplars, rather than limitations on the apparatus and methods of the present invention.

An embodiment of the invention will be hereinafter explained in detail with reference to the drawings. In the respective figures, identical components are denoted by identical reference numerals and signs

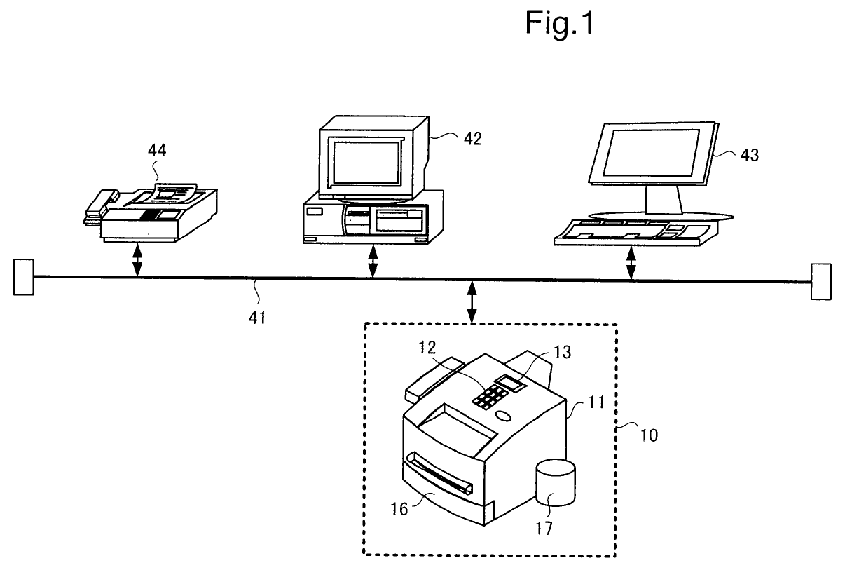

FIG. 1 is a diagram of a network that uses an image forming apparatus of the invention. In the following explanation, an example in which an MFP (Multi-Function Peripherals) is used as the image forming apparatus will be explained. However, it is also possible to apply the invention to a printer, a copying machine, and other image forming apparatuses.

In FIG. 1, reference numeral 10 denotes an MFP. An operation unit 12 is provided in an upper portion of a main body 11 of the MFP. The operation unit 12 has various keys for setting operation conditions and includes a start key, a ten key, a copy key, a scan key, a print key, a facsimile key, and a setting/registration key. A display unit 13 of a liquid crystal or the like is provided adjacent to the operation unit 12.

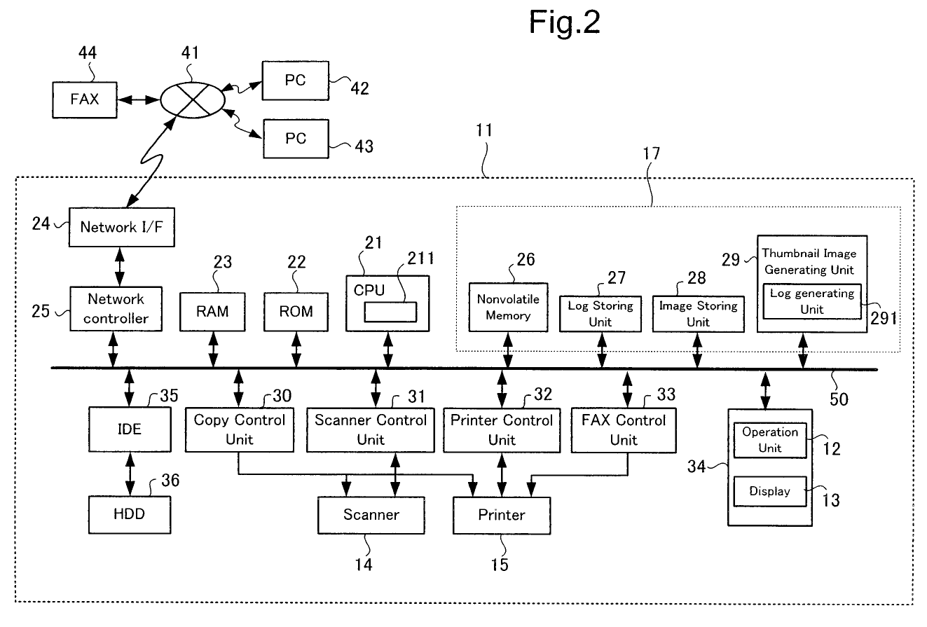

A document table is provided in an upper portion of the MFP 10. An auto document feeder (ADF) is provided on the document table to be freely opened and closed. The MFP 10 has a scanner 14 and a printer 15 shown in FIG. 2 in the main body 11. A cassette 16 having sheets of various sizes stored therein is provided in a lower portion of the main body 11. A database 17 is connected to the main body 11. The database 17 may be built in the main body 11 or may be externally attached to the main body 11.

Examples of job functions of the image forming apparatus 10 include a printer function, a scan function, a color copy function, a network print function, and a fax function.

The printer function is a function for printing image data. The scan function includes a function for coping image data read by the scanner 14, a file function for storing image data scanned by the main body 11 in a PC (personal computer) or the like described later, and a mail function for transmitting the image data scanned by the main body 11 to external apparatuses in a form of an e-mail. The network print function is a function for printing, on the main body 11 side, image data sent from the external apparatuses to the main body 11. The fax function is a function for transmitting image data by fax.

The MFP 10 is connectable to the external apparatuses via a network 41. As the external apparatuses, there are PCs (personal computers) 42 and 43, a facsimile apparatus 44, and the like. For example, the PC 42 is used by a general user and the PC 43 is used by an administrator.

FIG. 2 is a block diagram showing a structure in the main body 11 of the image forming apparatus.

A CPU 21 is provided in the main body 11 of the image forming apparatus. The CPU 21 includes a control unit 211 and is connected to a PCI bus 50. The PCI bus is the abbreviation of Peripheral Component Interconnect Bus. A ROM 22 and a RAM 23 are connected to the PCI bus 50. Various control programs necessary for operations of the main body 11 are stored in the ROM 22. The RAM 23 stores various data. A network interface 24 is provided in the main body 11. The network interface 24 is connected to the PCI bus 50 via a network controller 25.

The network interface 24 includes a LAN board and a FAX modem and is connected to the external apparatuses, for example, the PCs 42 and 43 and the facsimile apparatus 44 via the network 41. The network controller 25 controls data transmission and reception between the MFP 10 and the external apparatuses via the network interface 24.

The database 17 is further connected to the PCI bus 50. The database 17 includes a nonvolatile memory 26, a log storing unit 27, an image storing unit 28, and a thumbnail image generating unit 29. The nonvolatile memory 26, the log storing unit 27, the image storing unit 28, and the thumbnail image generating unit 29 are connected to the PCI bus 55. The thumbnail image generating unit 29 has a log generating unit 291. The nonvolatile memory 26 may be provided separately from the database 17 rather than in the database 17 and connected to the PCI bus 55.

A copy control unit 30, a scanner control unit 31, a printer control unit 32, a FAX control unit 33, and an operation panel 34 are further connected to the PCI bus 55. An HDD (hard disk device) 36 is connected to the PCI bus 55 via an IDE 35. The IDE 35 is an interface for connecting the HDD 36 to the PCI bus 55. IDE is the abbreviation of Integrated Device Electronics. The operation panel 34 includes the operation unit 12 and the display unit 13.

The copy control unit 30 controls a usual copy function that uses the scanner 14 and the printer 15. The scanner control unit 31 controls a scan function that uses the scanner 15, a file function for storing scanned image data in the PC 42, and an e-mail function for transmitting image data to the external apparatuses. The printer control unit 32 controls a print function or a network print function that uses the printer 15. The facsimile control unit 33 controls a facsimile function. Image data to be subjected to print processing by the printer 15 is stored in the HDD 36.

The control unit 211 of the CPU 21 constitutes a job managing unit that controls the copy control unit 30, the scanner control unit 31, the printer control unit 32, and the FAX control unit 33.

Operations of the image forming apparatus of the invention will be explained. Since the invention aims principally at generation of a thumbnail image, the generation of a thumbnail image will be hereinafter mainly explained.

In the invention, thumbnail logs are generated for job functions used (scan, copy, FAX transmission and reception, e-mail transmission and reception, network printing, etc.) to make it possible to display thumbnail images with job images superimposed thereon. The invention is characterized in that, in generating a thumbnail image, conditions are set and a user, a department, a date and time, a type of a job, a print size, and the like are designated to generate a thumbnail image under designated conditions.

The conditions described above will be hereinafter explained in detail. As conditions for generating a thumbnail image, for example, the following (a) to (e) are conceivable.
(a) “Designate a user”: In the MFP 10 to which user management is applied, a user name, a user ID, and the like are designated and storage of thumbnail logs is executed only for jobs performed by the user. It is possible to select plural users.
(b) “Designate a department”: In the MFP 10 to which department management is applied, a department is designated and storage of thumbnail logs is executed only for jobs performed by users belonging to the department designated. It is possible to select plural departments.
(c) “Designate a date and time”: A range of date and time is designated and storage of thumbnail logs is executed only for jobs performed in the range of date and time designated. It is possible to select plural ranges, for example, designating a day of week and a predetermined time frame.
(d) “Designate a type of a job”: Type of jobs (scan, copying, FAX transmission and reception, e-mail transmission and reception, network printing, etc.) are designated and storage of thumbnail logs is executed only when the jobs designated are performed. It is possible to select plural kinds of jobs.
(e) “Designate a size”: A size of a scanned image or a size of a print sheet is designated and storage of thumbnail logs is executed only when jobs of the size designated are performed. It is possible to select plural sizes.

It is possible to select plural conditions among the conditions (a) to (e). When plural conditions are selected, for example, the conditions are set as OR or AND conditions. It is also possible to set other conditions, for example, set execution of color copy as a condition.

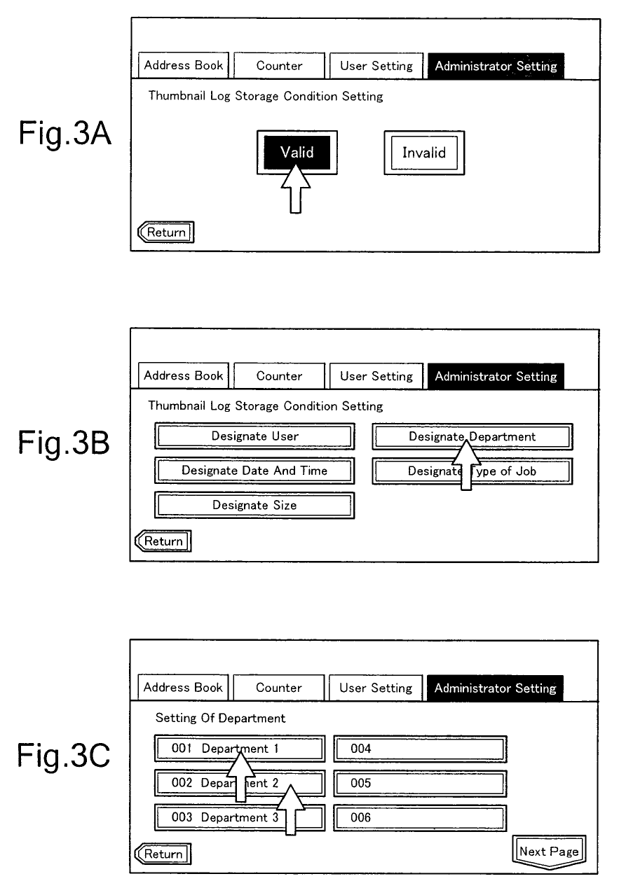

A way of storing a thumbnail log and a way of setting storage conditions will be explained with reference to FIGS. 3A to 3F. It is assumed that the MFP 10 is an MFP in which department management is valid. It is assumed that there are a “department 1”, a “department 2”, and a “department 3” as departments to be managed.

First, in order to validate a function for storing a thumbnail log, the administrator of the MFP 10 operates the setting/registration key of the operation unit 12 to display a setting screen shown in FIG. 3A on the display unit 13. The administrator selects “valid” using a cursor in order to execute storage of a thumbnail log from this screen.

Subsequently, a screen concerning conditions for storing a thumbnail log is displayed on the display unit 12 as shown in FIG. 3B. Five selection screens for condition setting are displayed. The administrator can select plural arbitrary conditions out of the conditions displayed. It is assumed that the administrator selects “designate a department” as a storage condition 1 for a thumbnail log.

Consequently, a list of departments currently registered is displayed on the display unit 12 as shown in FIG. 3C. The administrator selects an arbitrary department from the list of departments displayed. The administrator designates the “department 1” and the “department 2”. After the designation, the administrator selects an icon of “next page” to display a screen in FIG. 3D.

The screen in FIG. 3D is the same as the screen concerning the storage conditions in FIG. 3B. However, since the departments are designated as the condition 1, an item of “designate a department” is displayed in a different color. In FIG. 3D, the administrator can select an arbitrary condition other than the condition 1. It is assumed that the administrator selects “designate a type of a job” as a second condition.

When “designate a type of a job” is selected, a screen shown in FIG. 3E is displayed. In FIG. 3E, types of jobs that can be processed by the MFP 10 are displayed and, for example, items of scan, copying, FAX transmission, FAX reception, e-mail transmission, e-mail reception, and network printing are displayed. The administrator can select an arbitrary job out of the types of jobs. It is assumed that the administrator designates “copying” and “FAX transmission”. Consequently, as shown in FIG. 3F, two conditions “designate a department” and “designate a type of a job” are set.

In this way, the storage of a thumbnail log and the setting of storage conditions are completed. When the setting is completed, the CPU 21 stores content set in the nonvolatile memory 26.

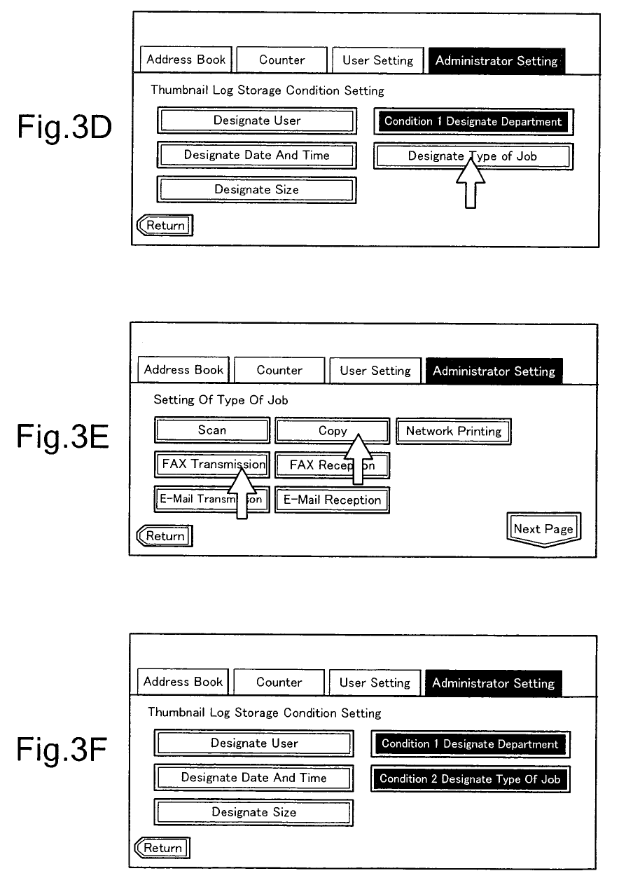

FIG. 4 is a diagram showing content stored in the nonvolatile memory 26. The function for storing a thumbnail log is “valid” and the conditions for storing a thumbnail log are “yes”. Among the conditions set, the “department 1” and the “department 2” are set as departments “Copying” and “FAX transmission” are set as types of jobs. In the example in FIG. 4, storage of a thumbnail log is executed when users belonging to the “department 1” and the “department 2” carry out copying or FAX transmission.

Control up to thumbnail log storage in the case in which a jog is actually carried out using the MFP 10 will be explained. First, control in the case in which a user belonging to the “department 1” carries out copying will be described.

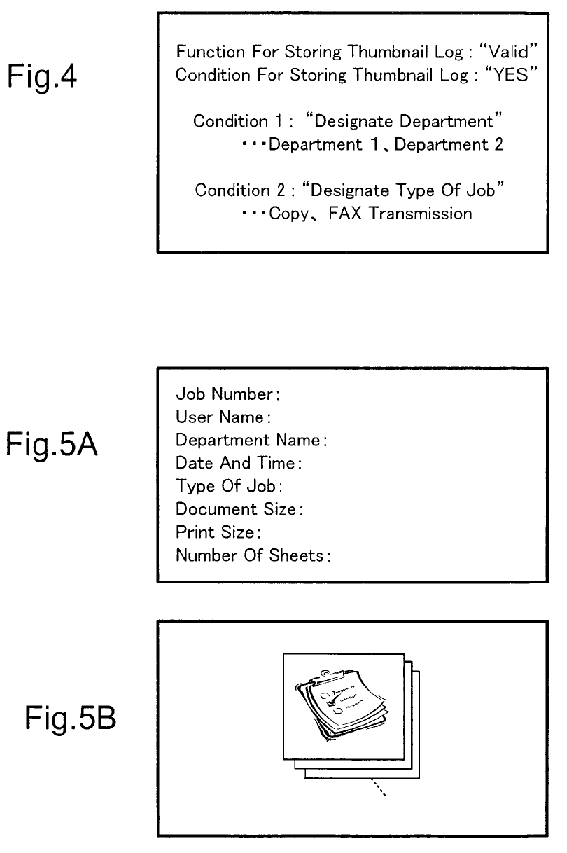

When the user belonging to the “department 1” logs in to the MFP 10 and performs copying as the “department 1”, the CPU 21 judges a type of the job executed and generates a job log shown in FIG. 5A and stores the job log in the log storing unit 27. As the job log, there is information on a job number (a job serial number), a department name (and a user name when user management is carried out), a date and time the job is carried out, a type of the job, an original size, a sheet size, and the number of sheets. These kinds of information are stored in the log storing unit 27 as a job log.

After the copy operation and the storage of the job log end, the CPU 21 judges, with reference to the content of the nonvolatile memory 26, whether the function for storing a thumbnail log is set as “valid” and the conditions for storing a thumbnail log are set. In the present case, since the function for storing a thumbnail log is “valid” and the conditions are set, the CPU 21 refers to the storage conditions in the data stored in the log storing unit 27 and extracts a job log meeting the conditions.

Data of a job image shown in FIG. 5B is stored in the image storing unit 28. For example, data of a job image representing types of copy, network printing, and the like is stored. Image data of a job actually executed (copy in the present case) is extracted.

The thumbnail image generating unit 29 performs extraction of a job log from the log storing unit 27 and extraction of image data from the image storing unit 28 under the control by the CPU 21. The log generating unit 291 of the thumbnail image generating unit 29 generates a thumbnail log on the basis of the job log extracted. The thumbnail image generating unit 29 generates a thumbnail image using the thumbnail log generated in the log generating unit 291 and the job image data extracted from the image storing unit 28.

In this way, the thumbnail image generating unit 29 generates a thumbnail image in accordance with the conditions and stores the thumbnail image, and stores a list of thumbnails. Therefore, the administrator is capable of watching the thumbnail image by operating the PC 43 to access the database 17.

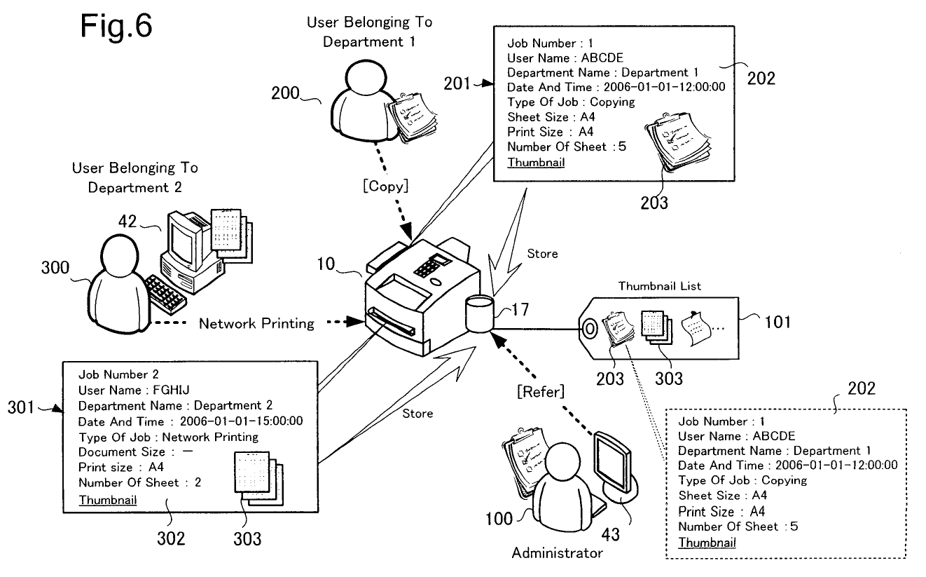

FIG. 6 is a diagram for explaining generation of a thumbnail image according to the invention and an operation for displaying the thumbnail image. In FIG. 6, reference numeral 100 denotes an administrator, who operates the PC 43. Reference numeral 200 denotes a user belonging to the “department 1”. The user 200 is assumed to be a person who performs copying using the MPF 10. Reference numeral 300 denotes a user belonging to the “department 2”. The user 300 is assumed to be a person who operates the PC 42 to perform network printing.

When the user 200 executes copying using the MFP 10, a thumbnail image 201 consisting of a thumbnail log 202 indicating a job history of the copying and a job image 203 of the copying is generated. When the user 300 accesses the MFP 10 from the PC 42 and executes network printing, a thumbnail image 301 consisting of a thumbnail log 302 indicating the network printing and a job image 303 of the network printing is generated.

On the other hand, the administrator 100 can refer to histories of use of the MPF 10 by the users 200 and 300 by operating the PC 43 to access the MFP 10. For example, a thumbnail list 101 is displayed on a screen of the PC 43. When the administrator 100 selects and clicks the job image 203 of copying in the list, the thumbnail log 202 indicated by a dotted line frame is displayed.

The thumbnail log 202 includes information on a job number, a user name, a department name, a date and time, a type of a job, a document size, a sheet size, and the number of sheets. The administrator 100 can check thumbnail logs with content meeting conditions set in advance. When the administrator selects the job image 303 of the network printing in the list 101, the thumbnail log 302 is displayed.

When a user in a department not meeting the conditions set in advance uses the MFP 10 or when a job not meeting the conditions set in advance is executed, thumbnail display is not performed and it is possible to delete unnecessary information. Therefore, since a thumbnail image is generated on the basis of the conditions set by the administrator, in retrieving a specific image out of thumbnail images, the administrator can easily retrieve the image.

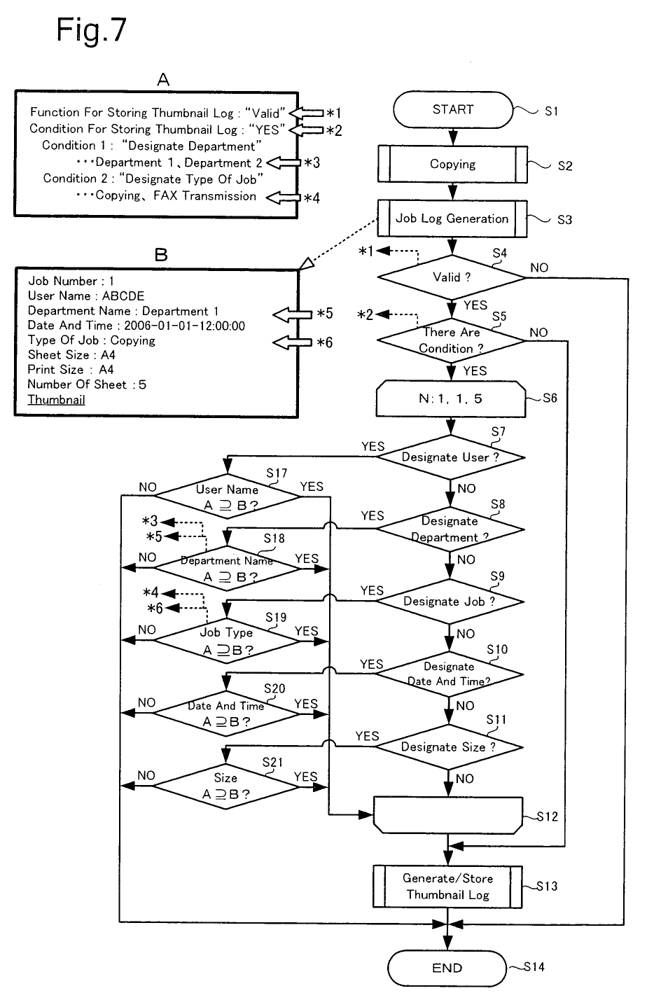

FIG. 7 is a flowchart for explaining operations of processing for generating a thumbnail log. In FIG. 7, A is a reference diagram showing storage conditions and the like for a thumbnail log stored in the nonvolatile memory 26 and B is a reference diagram showing a job log stored in the log storing unit 27. Arrow signs *1 to *6 indicate items referred to in a judgment step of the flowchart.

Step S1 is a start step of the operations. A job is executed in step S2. It is assumed that copying is executed. In step S3, the job log shown in the reference diagram B is generated in response to copy processing and stored in the log storing unit 27 of the database 17.

In the next step S4, it is judged, with reference to *1, whether a function for storing a thumbnail log is valid. If the function is valid, the processing proceeds to step S5. When the function is not valid, the processing shifts to end step S14 and a thumbnail log is not generated. In step S5, it is judged, with reference to *2, whether conditions for storing a thumbnail log are present. When the conditions are set, the processing proceeds to a sum loop in step S6. When the conditions are not set, the processing shifts to step S13.

“N:1, 1, 5” of the sum loop in step S6 indicates that an initial value of N is 1 and incremented only once. A maximum value of N is 5. When the processing ends at N=5, the entire processing ends. The CPU 21 compares the storage conditions in the reference diagram A and the job log in the reference diagram B in the following five steps.

In steps S7 to S11, it is judged “whether a user is designated”, “whether a department is designated”, “whether a job is designated”, “whether a date and time is designated”, and “whether a size is designated”, respectively. If results of the judgment in steps S7 to S11 are NO, the processing sequentially proceeds to step S12 via the next steps. If results of the judgment in steps S7 to S11 are YES, the processing shifts to steps S17 to S21 and the next judgment is performed.

In steps S17 to S21, it is judged whether the information in the reference diagram B is included in the information in the reference diagram A. If the judgment in the respective steps S17 to S21 is NO, the processing shifts to step S14. If the judgment in steps S17 to S21 is YES, the processing shifts to step S12.

In the present example, since the conditions are set for the department and the type of a job, in step S18, it is judged, with reference to *3 and *5, which department is designated.

In this case, since the setting conditions in the reference diagram A are the “department 1” and the “department 2” and the “department 1” is included in the reference diagram B, the judgment in step S18 is YES and the processing proceeds to step S12. Similarly, in step S19, it is judged, with reference to *4 and *6, which job type is designated. Since the setting conditions in the reference diagram A are “copying” and “FAX transmission” and “copying” is included in the reference diagram B, the judgment in step S19 is YES and the processing proceeds to step S12.

Since other conditions are not set, in step S12, after loop processing is executed five times, it is judged that the conditions for storing all the thumbnail logs set are met. In the next step S13, the log generating unit 291 generates a thumbnail log, executes storage processing, and proceeds to end step S14.

In this way, the thumbnail image generating unit 29 can generate a thumbnail image using the thumbnail log generated by the log generating unit 291. Since the thumbnail log and the image job stored in the image storing unit 28 are used, the thumbnail image can be more easily seen.

As described above, in the invention, it is possible to prevent an excessive increase in size of log data by designating conditions for executing storage of a thumbnail log. Since generation of log data is limited to generation designated, it is easy to retrieve necessary log information.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus capable of executing plural jobs and capable of generating a thumbnail image representing a history of execution of the jobs, the image forming apparatus comprising:
a condition setting unit configured to set a condition for generating the thumbnail image;
a log generating unit configured to generate a thumbnail log of the job executed on the basis of the condition set by the condition setting unit, when any one of the jobs is executed in the image forming apparatus; and
a thumbnail image generating unit configured to generate a thumbnail image using the thumbnail log generated by the log generating unit.

2. An image forming apparatus according to claim 1, wherein
the condition setting unit designates a user as the condition for generating the thumbnail image, and
the log generating unit generates the thumbnail log when the user designated executes any one of the jobs.

3. An image forming apparatus according to claim 1, wherein
the condition setting unit designates a department as the condition for generating the thumbnail image, and
the log generating unit generates the thumbnail log when a user belonging to the department designated executes any one of the jobs.

4. An image forming apparatus according to claim 1, wherein
the condition setting unit designates a date and time as the condition for generating the thumbnail image, and
the log generating unit generates the thumbnail log when a job is executed in a range of the date and time designated.

5. An image forming apparatus according to claim 1, wherein
the condition setting unit designates a type of a job as the condition for generating the thumbnail image, and
the log generating unit generates the thumbnail log when the job of the type designated is executed.

6. An image forming apparatus according to claim 1, wherein
the condition setting unit designates a size as the condition for generating the thumbnail image, and
the log generating unit generates the thumbnail log when a size of an image scanned by the image forming apparatus or a size of a sheet printed by the image forming apparatus coincides with the size designated.

7. An image forming apparatus according to claim 1, wherein the image forming apparatus is connectable to a network and makes it possible to browse the thumbnail images generated using an external apparatus connected to the network.

8. An image forming apparatus according to claim 1, wherein the image forming apparatus is connectable to a network and makes it possible to execute a job of the image forming apparatus via an external apparatus connected to the network.

9. An image forming apparatus capable of executing plural jobs and capable of generating a thumbnail image representing a history of execution of the jobs, the image forming apparatus comprising:
a condition setting unit configured to set a condition for generating the thumbnail image;
a nonvolatile memory that stores the condition for generating the thumbnail image set by the condition setting unit;
a log storing unit configured to generates and memorizes a job log concerning the job executed, when any one of the jobs is executed; and
a thumbnail image generating unit configured to extract a job log meeting the generation condition from the log storing unit, on the basis of the generation condition stored in the nonvolatile memory, and generate a thumbnail image using the job log extracted.

10. An image forming apparatus according to claim 9, wherein
it is possible to set plural conditions for generating the thumbnail image, and
the thumbnail image generating unit sequentially compares job logs stored in the first storing unit and the plural conditions set by the condition setting unit and extracts job logs meeting the plural generation conditions to generate a thumbnail log.

11. An image forming apparatus according to claim 10, further comprising a second storing unit configured to store job images representing types of plural jobs, wherein
the thumbnail image generating unit extracts a job image meeting the generation conditions from the second storing unit and generates a thumbnail image using the job image extracted and the thumbnail log generated.

12. An image forming apparatus according to claim 11, wherein the thumbnail image generating unit is capable of generating a thumbnail list using the image jobs.

13. A thumbnail image generating method in an image forming apparatus capable of executing plural jobs, comprising:
setting a condition for generating a thumbnail image in order to generate a thumbnail image representing a history of execution of the jobs;
storing the condition for generating the thumbnail image set in a first storing unit;
generating a job logs concerning the job executed, when any one of the jobs is executed; and
extracting a job log meeting the generation condition stored in the first storing unit out of the job logs generated to generate a thumbnail image.

14. A thumbnail image generating method according to claim 13, further comprising:
sequentially comparing the job logs generated and the plural generation conditions stored in the first storing unit, when plural conditions for generating the thumbnail image are set in order to generate the thumbnail image; and
extracting job logs meeting the plural generation conditions to generate a thumbnail log and generating the thumbnail image using the thumbnail log.

15. A thumbnail image generating method according to claim 14, further comprising storing job images representing types of plural jobs in a second storing unit, extracting a job image meeting the generation conditions from the second storing unit in order to generate the thumbnail image, and generating a thumbnail image using the job image extracted and the thumbnail log generated.

16. An image forming apparatus capable of executing plural jobs and capable of generating a thumbnail image representing a history of execution of the jobs, the image forming apparatus comprising:
setting means for setting a condition for generating the thumbnail image;
log generating means for generating a thumbnail log of the job executed on the basis of the generation condition set by the setting means, when any one of the jobs is executed in the image forming apparatus; and
thumbnail image generating means for generating a thumbnail image using the thumbnail log generated by the log generating means.
